(19) United States
(12) Patent Application Publication
(10) Pub. No.: US 2015/0207578 A1
(43) Pub. Date: Jul. 23, 2015

(54) MULTICHANNEL WIRELESS LOCAL AREA NETWORK

(71) Applicant: Apple Inc., Cupertino, CA (US)

(72) Inventors: Harish Ramamurthy, Cupertino, CA (US); Joonsuk Kim, Saratoga, CA (US); Yong Liu, Campbell, CA (US); Christopher J. Hansen, Los Altos, CA (US)

(21) Appl. No.: 14/502,780

(22) Filed: Sep. 30, 2014

Related U.S. Application Data
(60) Provisional application No. 61/928,975, filed on Jan. 17, 2014.

(51) Int. Cl. H04J 1/08

(52) U.S. Cl. CPC H04J 1/08; H04W 88/08

(57) ABSTRACT

A multichannel wireless local area network (WLAN) using multiple radio frequency (RF) channels simultaneously for a basic service set (BSS) is described. The multichannel WLAN provides efficient use of RF bandwidth and improves throughput. An access point of the multichannel WLAN communicates with client devices using at least two parallel RF channels, which can be located in two different RF bands. The access point supports connections to client devices using a “legacy” mode over a single logical channel mapped to a single RF channel and includes data traffic, control traffic, and management frames combined. The access point also supports connections to client devices using a high efficiency WLAN mode having multiple logical channels, each logical channel associated with one or more physical RF channels. The multiple logical channels include a management channel for management frames and a separate high efficiency WLAN data channel to carry data traffic and control traffic.

### CROSS REFERENCE TO RELATED APPLICATIONS

This application claims the benefit of U.S. Provisional Application No. 61/928,975, filed Jan. 17, 2014 and entitled “MULTICHANNEL WIRELESS LOCAL AREA NETWORK”, which is incorporated by reference herein in its entirety for all purposes.

### FIELD

The described embodiments generally relate to wireless communication technology, and more particularly to extending capabilities of basis service sets of wireless local area networks to include multiple concurrent logical channels and physical radio frequency channels.

### BACKGROUND

Wireless networks are encountering exponential growth of Internet traffic, such as video traffic, web browsing traffic, and other data traffic that can be carried over the Internet. Continued growth in Internet traffic has spurred the development of new wireless communication protocols that can support wider bandwidths, a greater range of radio frequencies, and high throughput data rates. Given the costs and/or data traffic limits to communicate over cellular networks, users can prefer to communicate over “free” wireless local area networks (WLANs), subscription based WLANs, and/or operator provided WLANs. WLAN access is typically not predicated on usage based billing, so users can generally use WLANs without worrying about exceeding a data traffic cap and incurring higher resulting costs.

Many wireless communication devices that are capable of operating on both cellular networks and WLANs are typically configured to communicate data traffic over a WLAN when available, even when both wireless circuitry (also referred to as a radio) for WLAN communication and wireless circuitry for cellular communication are simultaneously active. Wireless access points can support communication via multiple wireless local area network communication protocols that use different radio frequency bands in parallel. Newer mobile station devices (also referred to as client devices) can also include such capabilities. With flexible use of different radio frequency channels in different radio frequency bands available to use in parallel by a client device, greater efficiency for management signaling and maintenance of radio links across different radio frequency bands can be desired.

### SUMMARY

A multichannel wireless local area network (WLAN) using multiple radio frequency (RF) channels simultaneously for a basic service set (BSS) using a single, common BSS identifier (BSSID) is described. The multichannel WLAN, which is also referred to as a “high efficiency” WLAN (or HEW), provides for efficient use of RF bandwidth and improves throughput. A HEW capable access point communicates with one or more HEW capable client devices using at least two parallel RF channels, which can be located in two different RF bands. The HEW capable access point also supports connections to “legacy” non-HEW capable client devices using a “legacy” mode over a single logical channel mapped to a single RF channel and includes data traffic, control traffic, and management frames combined. The HEW capable access point supports connections to HEW capable client devices using a high efficiency WLAN mode that supports communication over multiple logical channels, each logical channel associated with one or more physical RF channels. In some embodiments, at least one logical channel is associated with multiple physical RF channels. The multiple logical channels include a management channel that carries management frames and a separate high efficiency WLAN data channel that carries data traffic and control traffic separate from the management frames. A logical channel that carries management frames and a separate logical channel that carries data traffic and control traffic can be associated with multiple physical RF channels, which can belong to one or more radio frequency bands. In some embodiments, the logical channels belong to separate radio frequency bands that do not overlap. In some embodiments, the management frames include one or more of: beacon frames, probe requests, probe responses, authentication frames, association requests, and association responses. In some embodiments, multiple logical channels that are associated with at least two different physical radio frequency channels used in parallel are also associated with a single, common BSSID.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a wireless communication system, in accordance with some embodiments.

FIG. 2 illustrates another wireless communication system, in accordance with some embodiments.

FIG. 3 illustrates a further wireless communication system, in accordance with some embodiments.

FIG. 4A to FIG. 4C illustrate representative sets of parallel radio frequency channels for use in a radio frequency band by a wireless communication system, in accordance with some embodiments.

FIG. 5 illustrates a representative set of elements of a wireless communication device that can operate in accordance with some embodiments.

### DETAILED DESCRIPTION

Wireless local area networks currently can include a set of client devices (which can also be referred to as mobile station devices) in communication with an access point (or operating in an “ad hoc” peer-to-peer mode in communication with each other without a dedicated access point) to form a basic service set (BSS). In a BSS, as defined for an 802.11 wireless local area network, e.g., a Wi-Fi network, a unique BSS identifier (BSSID) can be used, and all client devices associated with the access point can communicate with the access point (or with each other) using a common radio frequency channel, e.g., a radio frequency channel selected from a set of radio frequency channels available for communication a radio frequency band. While the radio frequency channel used by the access point and client devices can change over time, parallel radio frequency channels are currently not used for a single BSS.

Herein, we extend the concept of an 802.11 BSS to include multiple, distinct radio frequency channels to provide for more efficient use of radio frequency bandwidth and to improve throughput performance of communication by wireless devices. In some embodiments, an access point communicates simultaneously with one or more client devices using at least two parallel radio frequency channels, which in some embodiments can be located in two different radio frequency bands. For example one radio frequency channel can be in a 2.4 GHz radio frequency band and a second radio frequency channel can be in a 5.0 GHz radio frequency band. The access point can support connections to some client devices using a “legacy” mode over a single operational channel in accordance with a “legacy” wireless local area network communication protocol, e.g., a Wi-Fi protocol, in which the single operational channel is mapped to a single radio frequency channel and includes data traffic, control traffic, and management frames combined into the single operational channel. The access point can also support connections to some client devices using a high efficiency WLAN mode that supports multiple logical channels in parallel, with each logical channel associated with one or more different physical radio frequency channels.

The multiple logical channels used in the high efficiency WLAN mode can include a management channel for all client devices that support the high efficiency WLAN communication, and the management channel can carry management frames, e.g., beacon frames, probe requests, probe responses, authentication frames, association requests, and association responses. The multiple logical channels can also include a separate high efficiency WLAN data channel to carry data traffic and control traffic for all high efficiency WLAN client devices. In some embodiments, the management channel is associated with a single physical radio frequency channel. In some embodiments, the management channel is associated with multiple physical radio frequency channels. In some embodiments, the high efficiency WLAN data channel is associated with one or more physical radio frequency channels. A physical radio frequency channel can be defined as a combination of a center frequency (or carrier frequency) and a bandwidth. When a legacy operational channel (mapped to a physical radio frequency channel) overlaps with a high efficiency WLAN data channel (which can be mapped to one or more physical radio frequency channels) in the frequency domain, the overlapping physical radio frequency channels can be time multiplexed to permit time periods for different accesses, such as (1) high efficiency WLAN access only, (2) combinations of high efficiency WLAN access and legacy data access, and, in some embodiments, (3) legacy data access only.

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), and/or 5G or other present or future developed advanced cellular wireless networks. The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

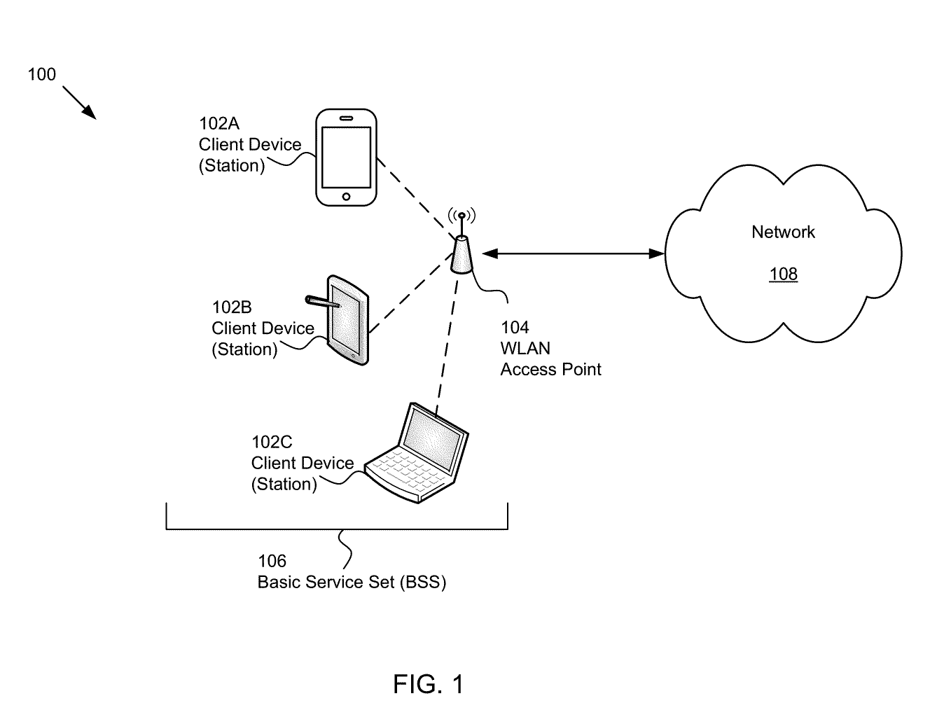

FIG. 1 illustrates a wireless communication system 100 in accordance with some example embodiments. The wireless communication system 100 can include a set of client devices 102A, 102B, and 102C, which can also be referred to as stations, client wireless devices, or client wireless communication devices, interconnected to an access point (AP) 104. The client devices 102A, 102B, and 102C can be any wireless communication device that can be capable of communicating via a wireless local area network (WLAN) technology, e.g., in accordance with a wireless local area network communication protocol. In some embodiments, the WLAN technology can include a Wi-Fi (or more generically a WLAN) wireless communication subsystem or radio, and the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies. By way of non-limiting example, the client devices 102A, 102B, and 102C can be embodied as a cellular phone, such as a smart phone device, a tablet computing device, a laptop computing device, and/or other computing device that can be configured to communicate over a WLAN connection.

In some embodiments, the client devices 102A, 102B, and 102C can also communicate in accordance with a wireless cellular communication protocol with a cellular wireless network (not shown). The client devices 102A, 102B, and 102C can communicate with a network 108, e.g., the “Internet,” via the WLAN access point 104. The set of client devices 102A, 102B, and 102C together with the WLAN access point 104 can form a basic service set (BSS) 106 and can communicate using a common radio frequency channel specified by a WLAN communication protocol, e.g., an 802.11 radio frequency channel of a Wi-Fi communication protocol. The BSS can be identified uniquely by a basic service set identifier (BSSID), which in some embodiments can include a medium access control (MAC) address of the WLAN access point 104. The set of 802.11 Wi-Fi communication protocols utilize radio frequency spectrum in the Industrial, Scientific, and Medical (ISM) radio frequency bands, e.g., from 2.4 to 2.5 GHz, as well as the “5 GHz” radio frequency band, e.g., spanning from approximately 4.9 to 5.8 GHz. The “higher” radio frequency bands can provide for wider radio frequency channels that offer more bandwidth and higher data rates. The “lower” radio frequency bands can provide a wider coverage area due to lower path loss and therefore greater range. Typically, client devices 102A/B/C and WLAN access points 104 offer the capability to operate in one or both radio frequency bands. Additional radio frequency bands are planned for future use, and wireless communication protocols are being developed and standardized to use additional radio frequency bands, including those radio frequency bands in the television “white space” frequencies, e.g. in the very high frequency (VHF) and ultra high frequency (UHF) bands, i.e., near 600 MHz, as well as at frequencies near 3.5 GHz.

The BSS can include a set of client devices (stations), e.g., 102 A/B/C, and the WLAN AP 104 that use a common radio frequency channel. In some embodiments, an “independent” BSS can include a set of client devices interconnected to each other as an “ad hoc” peer-to-peer wireless network without including an access point. In some embodiments, an “infrastructure” BSS can include both client devices (stations) and an access point, e.g., as depicted in FIG. 1. Wireless communication protocols, including 802.11 Wi-Fi communication protocols, can provide for flexibility in the use of different radio frequency channels to maximize performance (e.g., throughput) and minimize radio frequency (RF) interference (both ingress RF interference received by a wireless device when using a selected radio frequency channel and egress RF interference from a wireless device into other wireless systems that use overlapping and/or adjacent radio frequency channels). A representative WLAN access point 104 can provide for dual radio frequency band operation, e.g., in the 2.4 GHz radio frequency band and also in the 5.0 GHz radio frequency band. The WLAN access point 104 can provide for simultaneous communication in more than one radio frequency band using different radio frequency channels, with each radio frequency channel in each radio frequency band associated with a distinct BSSID. Thus, the WLAN AP 104 can act as two separate parallel AP's within the same common hardware unit.

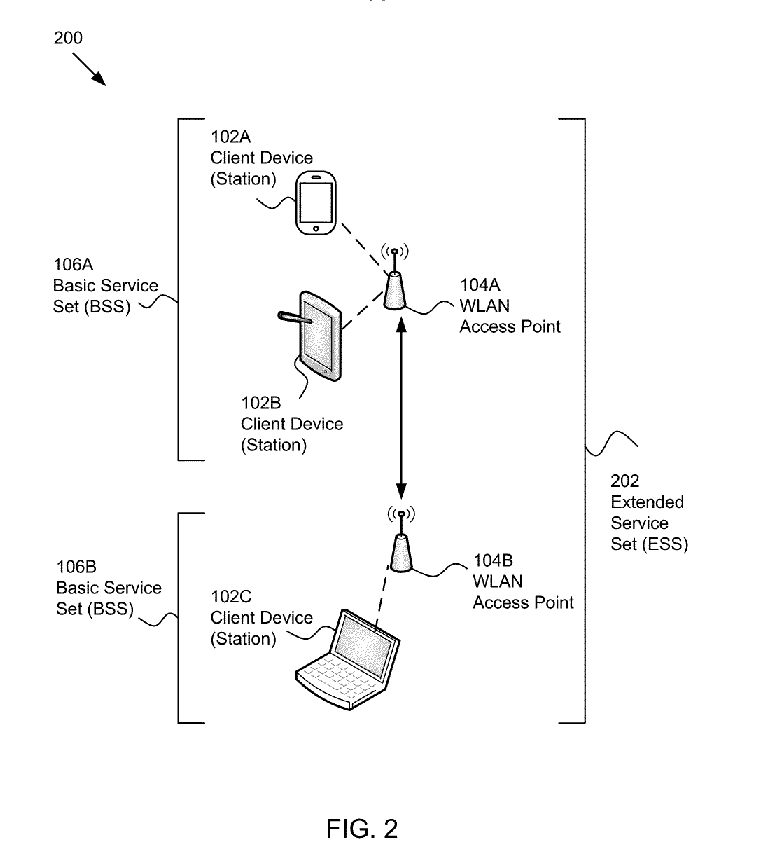

FIG. 2 illustrates a wireless communication system 200 that includes two different basic service sets (BSSs) 106A and 106B associated with WLAN access points 104A and 104B respectively and interconnected together to form an extended service set (ESS) 202. The ESS 202 can be identified by a separate identifier referred to as a service set identifier (SSID), which can be a “name” given to the set of interconnected APs that jointly provide wireless access to an Internet Protocol (IP) network, e.g., network 108 as shown in FIG. 1 (not shown in FIG. 2). As illustrated in FIG. 2, the WLAN AP 102A can communicate with client devices 102A and 102B using one radio frequency channel to form the first BSS 106A, while the WLAN AP 102B can communicate with the client device 102C using a separate radio frequency channel to form the second BSS 106B. The first BSS 106A and the second BSS 106B together can form the ESS 202. The ESS 202 can provide for client devices 102A/B/C to “roam” between the constituent BSSs 106A and 106B.

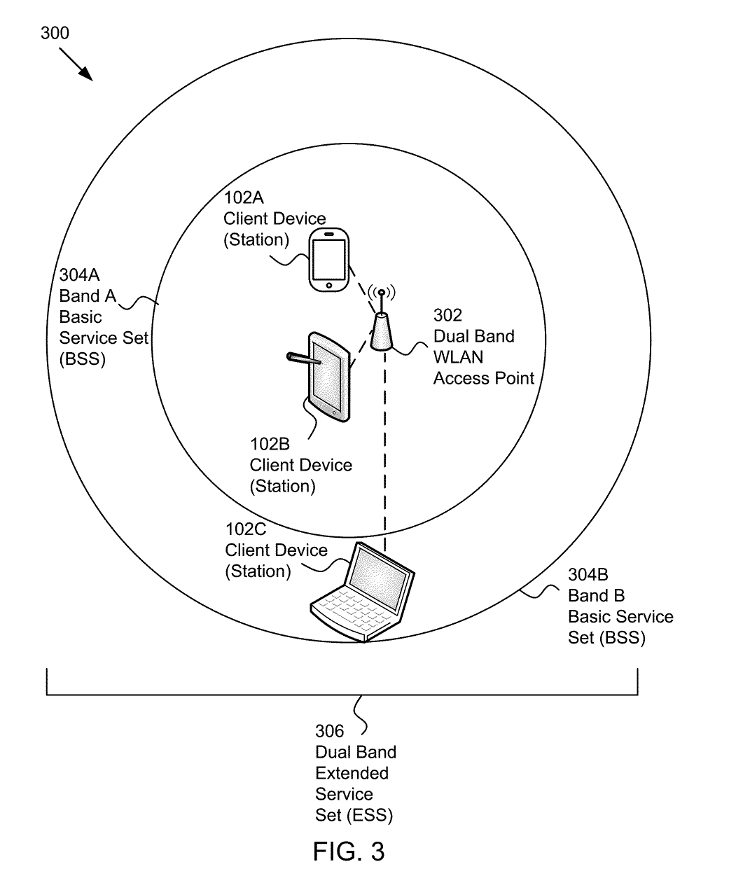

FIG. 3 illustrates a wireless communication system 300 that includes a “dual band” WLAN access point 302, which can communicate simultaneously using a first radio frequency channel in a first radio frequency band, e.g., the 5.0 GHz band, to form a first basic service set, namely the “Band A” BSS 304A, which can include one or more client devices, e.g., client device 102A and client device 102B. The “dual band” WLAN AP 302 can also communicate using a second radio frequency channel in a second radio frequency band, e.g., the 2.4 GHz band, to form a second basic service set, namely the “Band B” BSS 304B, which can include another client device 102C. Transmissions that use higher radio frequency bands can have a shorter range due to higher path loss than lower radio frequency bands, and thus the coverage area of the “Band B” BSS 304B can extend further from the “dual band” WLAN AP 302 than the coverage area of the “Band A” BSS 304A. Together the “Band A” BSS 304A and the “Band B” BSS 304B can form a “dual band” ESS 306. A client device can “roam” between the “Band A” BSS 304A and the “Band B” BSS 304B, and the overlapping radio frequency band coverage areas can provide a tradeoff between data rates and range. Typically, the higher radio frequency bands can provide more total bandwidth for radio frequency channels, which can thus provide higher data rates by using wider radio frequency channels.

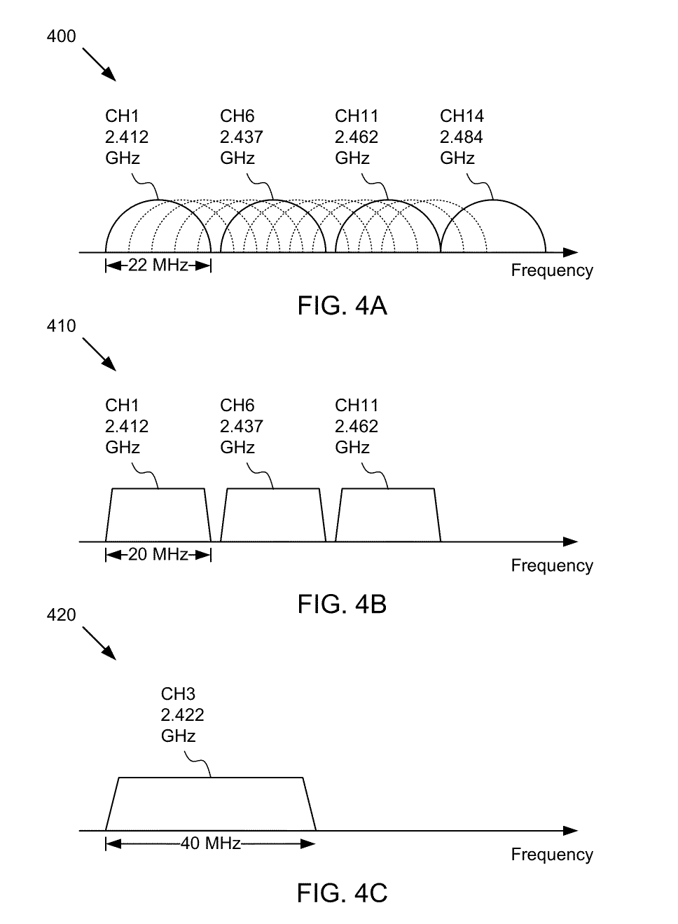

FIG. 4A illustrates a representative set of overlapping radio frequency channels, each radio frequency channel spanning approximately 22 MHz, in the 2.4 GHz radio frequency band in accordance with an 802.11b wireless communication protocol. An access point can select from among the different radio frequency channels on which to operate to minimize radio frequency interference to/from other wireless communication devices operating nearby. FIG. 4B illustrates a representative set of non-overlapping radio frequency channels, each spanning approximately 20 MHz, in the 2.4 GHz radio frequency band in accordance with an 802.11g wireless communication protocol. FIG. 4C illustrates a representative radio frequency channel spanning 40 MHz, in the 2.4 GHz radio frequency band in accordance with an 802.11n wireless communication protocol. FIG. 4A and FIG. 4B illustrate that within the 2.4 GHz radio frequency band, the 802.11b/g wireless communication protocols typically use radio frequency channels spanning 20-22 MHz, while FIG. 4C illustrates that the 802.11n wireless communication protocol provides for 40 MHz wide radio frequency channels. Furthermore, within the 5.0 GHz radio frequency band (not shown), the 802.11ac wireless communication protocol provides for 80 MHz and 160 MHz wide radio frequency channels. The wider radio frequency channels can provide for significantly higher data rates. In addition, multiple-input multiple-output (MIMO) wireless systems can offer higher antenna densities to achieve higher data rates, to provide greater redundancy, or both, and can be easier to develop for use at higher radio frequencies. For example, antenna spacing in client devices and/or in access points can be based on wavelengths (or fractions thereof) for radio frequencies used for communication, and higher radio frequencies, with smaller wavelengths, can provide for closer spacing of antennas therein.

As both access points and client devices can include wireless circuitry that permits the use of multiple radio frequency channels simultaneously, and/or provides for flexible use of different radio frequency channels, it can be desired to extend the capabilities of a basic service set (BSS) beyond a single radio frequency channel as used today. Different BSSs can operate using different radio frequency channels, usually selected to be non-overlapping channels within a geographic coverage area to minimize radio frequency interference between the parallel radio frequency channels used by the different BSSs. Each BSS can require management signaling to be carried on each radio frequency channel that is used in each radio frequency band used, which can result in a significant amount of redundant management signaling communicated in all of the radio frequency channels that are used in the same and in different radio frequency bands in parallel. Management signaling can include frames provided to maintain communication of the BSS, e.g., authentication frames, association request and response frames, beacon frames, and probe request and response frames. Transitioning a client device from one radio frequency channel to another radio frequency channel can require a re-association (roaming) operation to be performed by the client device with the access point. Signaling overhead, e.g., multiple management frames communicated over a radio frequency channel, and security overhead, e.g., new key generation, can be required for the client device to send data over a different radio frequency channel from the radio frequency channel in current use. Management signaling overhead to use different radio frequency channels can inhibit coordination among multiple BSSs and can complicate the operation of peer-to-peer (P2P) WLANs.

In addition, power (e.g., supplied from limited power storage in battery operated wireless devices) and radio frequency bandwidth can be wasted when a wireless client device is associated with a radio frequency channel in a radio frequency band that is sub-optimal for an underlying application that provides/consumes data using the radio frequency channel. The wireless radio frequency spectrum can be used inefficiently when a “lower data rate” application uses a “higher data rate” capable radio frequency channel, thus limiting available radio frequency resources for other users that share the same radio frequency channel/band. Wireless client devices can also be required to devote significant battery resources to scan for available radio frequency channels and to maintain management communication and operations across different radio frequency channels in parallel. Furthermore, connectivity of a wireless communication device with an access point (or in an “ad hoc” wireless network with other wireless communication devices) can be subject to interruption due to unnecessary radio frequency scanning and monitoring of maintenance messages (frames) by the wireless communication device and to provide for transitions between different radio frequency channels, within a common radio frequency band and/or across different radio frequency bands, e.g., when “roaming” from a radio frequency channel in the 2.4 GHz radio frequency band to a radio frequency channel in the 5.0 GHz radio frequency band. Thus, operating using only a single radio frequency channel by wireless communication devices and/or access points in a BSS can be less efficient than using multiple radio frequency channels in parallel.

A multichannel WLAN can provide for an AP to operate a BSS using multiple radio frequency channels simultaneously, which can be referred to as a multichannel BSS. In some embodiments, the multiple radio frequency channels can be in multiple non-overlapping radio frequency bands. In some embodiments, the multiple radio frequency channels can be in the same radio frequency band, e.g., a set of non-overlapping radio frequency channels within a particular radio frequency band, such as the radio frequency channels selected from those available for the 2.4 GHz radio frequency band to form the set of CH1, CH6, CH11, and CH14 radio frequency channels as illustrated in FIG. 4A. Typically, a multichannel BSS can be distributed across different radio frequency channels among different radio frequency bands.

Associated with a multichannel BSS, three distinct logical channels can be defined. Each distinct logical channel can be mapped to a single, common, physical radio frequency channel or can be mapped to multiple, parallel, physical radio frequency channels. Thus, the logical channels can be mapped to different physical radio frequency channels within a common radio frequency band and/or to different physical radio frequency channels across multiple radio frequency bands. A physical radio frequency channel can be defined as a combination of a center frequency and a bandwidth of radio frequency spectrum about that center frequency used for wireless radio frequency communication.

The logical channels can include a “legacy” channel, which can operate in a manner consistent with “legacy” client devices, e.g., including both management frames and data traffic in the same legacy channel. In some embodiments, the “legacy” channel can be mapped to a single physical radio frequency channel occupying a radio frequency channel as defined in accordance with an IEEE 802.11x wireless communication protocol. The “legacy” client device can continue to operate on the multichannel BSS in a similar manner as used for a single channel BSS.

The logical channels can further include a “high efficiency” WLAN (HEW) management channel that can be used for signaling management frames for a set of HEW client devices. In an embodiment, the HEW management channel can be mapped to a single radio frequency channel in a particular radio frequency band, e.g., a radio frequency channel identified to have a longest range or coverage area, or determined to operate with minimal potential or actual radio frequency interference. Management frames, e.g., beacon frames, probe requests, probe responses, authentication frames, association request, association responses, etc., can be transported via the HEW management channel. In some embodiments, the HEW management channel can be duplicated and/or split among multiple radio frequency channels in multiple radio frequency bands. For example, in some embodiments, an HEW capable client device can monitor an HEW management channel in a radio frequency band in which the HEW capable client device also communicates data, without having to switch to a different radio frequency band to receive the HEW management channel.

The logical channels can further include an HEW data channel for communication of data between the HEW capable AP and one or more HEW capable client devices. The HEW data channel can include data and control frames/messages (which can be separate from management frames described herein). The HEW data channel can be used exclusively for data traffic and control traffic, while the HEW management channel can be used exclusively for management frames. Thus data traffic, control traffic, and management frames, which can be combined together for transport over a legacy operational channel, can instead be separated into two parallel logical channels for HEW capable devices. Each logical channel can use a common physical radio frequency channel or multiple physical radio frequency channels. Thus, logical channels can be flexibly assigned to different physical radio frequency channels as radio frequency spectrum availability and radio frequency conditions including interference can vary over time and in different locations. The logical channels need not be fixed to certain radio frequency channels or radio frequency bands, in some embodiments.

The HEW management logical channel can be used by client devices to “discover” an infrastructure BSS, a peer-to-peer BSS, and/or for service discovery. The HEW management logical channel can also be used for synchronization between an infrastructure BSS and a peer-to-peer BSS. The HEW management logical channel can also be used for resource coordination, e.g., to schedule resources on a data channel. Thus, the HEW management logical channel can be used to schedule a particular radio frequency channel and/or bandwidth and/or time slot and/or another radio frequency resource combination unit to communicate data based on capabilities of client devices that can be associated with an access point. Based on a capability of a client device and/or based on a current status of a client device and/or based on radio frequency conditions, the AP can use the HEW management logical channel to share use of a set of logical data channels among multiple client devices. The HEW management logical channel can be associated with a “legacy” radio frequency physical channel, in some embodiments, e.g., a radio frequency channel that is “lightly loaded” or otherwise typically available. A representative radio frequency physical channel that can be used for the HEW management logical channel can be the “legacy” channel number “165,” which can be associated with a radio frequency carrier at approximately 5.825 GHz in the 5 GHz radio frequency band. In some embodiments, the HEW management logical channel can be associated with a non-legacy radio frequency channel, e.g., with a radio frequency channel in the 900 MHz ISM radio frequency band, which can provide a high penetration (lower path loss) for communication on the radio frequency channel because of the lower carrier frequency used. In some embodiments, the HEW management logical channel can be associated with a relatively “narrow” bandwidth radio frequency channel, e.g., a radio frequency channel that uses less than 20 MHz of bandwidth, and can operate in the 2.4 GHz ISM radio frequency band, e.g., between channel 6 (at 2.437 GHz) and channel 11 (at 2.462 GHz).

The HEW data channel, in some embodiments, can be mapped to several noncontiguous physical radio frequency channels, which can be in the same radio frequency band or in different radio frequency bands, in some embodiments. Concurrent transmission of data on different, parallel radio frequency channels between an access point and a HEW client device can occur simultaneously. In some embodiments, the HEW client device can include radio frequency subsystems, including antennas, analog front ends, and digital processing circuitry to support parallel transmission and/or reception using multiple radio frequency channels. As legacy operational channels associated with particular radio frequency channels can overlap with the HEW data channel, communication by the HEW data channel on any partial overlapping and/or fully overlapping radio frequency channels (and/or on a shared radio frequency channel) can be divided into a first set of time periods during which only HEW capable devices, including both HEW capable access points and HEW capable client devices, can communicate and a second separate set of time periods during which both HEW capable devices and legacy “non-HEW” devices can communicate. During an “HEW only” time period, only HEW capable devices can be permitted to communicate, and access to use the radio frequency channel during the “HEW only” time periods can be scheduled by the access point to provide for efficient radio frequency channel access. During a “mixed” time period, in which both HEW capable devices and legacy non-HEW devices can communicate, the HEW capable devices can schedule communication to “share” the common and/or overlapping radio frequency channels (spectrum) thereby permitting “fair access” of the “shared” radio frequency resources to legacy non-HEW devices. For an HEW data channel that uses one or more radio frequency channels that are not shared and/or do not overlap with legacy non-HEW radio frequency channels, only HEW access time periods can be allocated (and mixed time periods can be not required).

In some embodiments, backward compatibility between a legacy non-HEW client device and an HEW capable AP can be maintained by operating in accordance with a standardized 802.11 MAC protocol. In some embodiments, a legacy non-HEW client device can be restricted to use only a particular logical channel and/or a single physical radio frequency channel and to operate in a manner consistent with being associated with a legacy non-HEW AP. Thus a legacy non-HEW client device can combine management frames, data traffic, and control messages on a common physical radio frequency channel as per current 802.11 communication protocols when associated with an HEW capable AP. When the common physical radio frequency channel used by the legacy non-HEW client device is shared between the legacy non-HEW client device and an HEW client device, the legacy non-HEW client device can defer data traffic by using a distributed coordination function (DCF) mechanism, in some embodiments. In some embodiments, a management logical channel can be used to schedule access to communication data traffic on a data logical channel, e.g., using a reservation mechanism or other comparable method.

A multichannel BSS can provide for communication among one or more APs and one or more client devices using multiple logical channels that can be mapped to multiple physical radio frequency channels. The multichannel BSS can use the same identifier, e.g., a BSSID, for all logical channels and/or physical radio frequency channels used. In some embodiments, a timing synchronization function (TSF) can be employed for all physical radio frequency channels in use and/or for all logical channels in use. In some embodiments, a multichannel WLAN AP can operate in an “awake” mode on all channels (logical and/or physical) at all times. In some embodiments, the multichannel WLAN AP can be required to remain “awake” on the HEW management channel at all times. In some embodiments, the multichannel WLAN AP can “sleep” on one or more HEW data channels during one or more “scheduled” time periods using a notification process; for example, a Wi-Fi P2P “Notice Of Absence” procedure can be used to schedule “awake” time periods and/or “sleep” time periods for the multichannel WLAN AP.

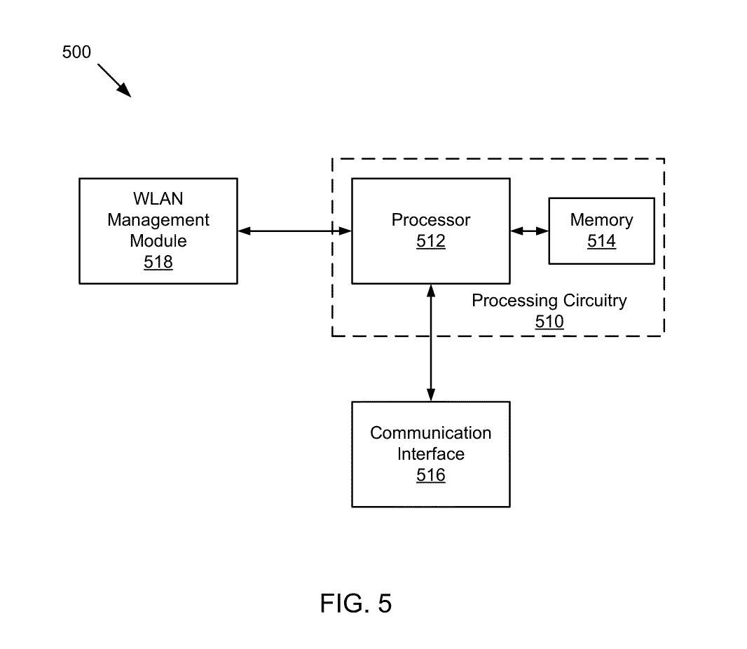

FIG. 5 illustrates a block diagram of an apparatus 500 that can be implemented on a multichannel WLAN capable client device and/or a multichannel WLAN capable access point, in accordance with some example embodiments. It will be appreciated that the components, devices or elements illustrated in and described with respect to FIG. 5 may not be mandatory and thus some may be omitted in certain embodiments. Additionally, some embodiments can include further or different components, devices or elements beyond those illustrated in and described with respect to FIG. 5. Further, it will be appreciated that, in some embodiments, one or more components of the apparatus 500 can be distributed across a plurality of computing devices that can collectively provide the functionality of a multichannel WLAN capable client device and/or a multichannel WLAN capable access point.

In some example embodiments, the apparatus 500 can include processing circuitry 510 that is configurable to perform actions in accordance with one or more example embodiments disclosed herein. In this regard, the processing circuitry 510 can be configured to perform and/or control performance of one or more functionalities of the apparatus 500 in accordance with various embodiments, and thus can provide means for performing functionalities of the apparatus 500 in accordance with various embodiments. The processing circuitry 510 can be configured to perform data processing, application execution and/or other processing and management services according to one or more embodiments.

In some embodiments, the apparatus 500 or a portion(s) or component(s) thereof, such as the processing circuitry 510, can include one or more chipsets, each of which can include one or more chips. The processing circuitry 510 and/or one or more further components of the apparatus 500 can therefore, in some instances, be configured to implement an embodiment on a chipset comprising one or more chips. In some example embodiments in which one or more components of the apparatus 500 are embodied as a chipset, the chipset can be capable of enabling a computing device(s) to operate as an offload coordination service server 116 when implemented on or otherwise operably coupled to the computing device(s).

In some example embodiments, the processing circuitry 510 can include a processor 512 and, in some embodiments, such as that illustrated in FIG. 5, can further include memory 514. The processing circuitry 510 can be in communication with or otherwise control a communication interface 516 and/or WLAN management module 518.

The processor 512 can be embodied in a variety of forms. For example, the processor 512 can be embodied as various processing hardware-based means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 512 can comprise a plurality of processors. The plurality of processors can be in operative communication with each other and can be collectively configured to perform one or more functionalities of the apparatus 500 as described herein. In embodiments including a plurality of processors, the plurality of processors can be implemented on a single computing device, or can be distributed across a plurality of computing devices that can collectively provide functionality of a multichannel WLAN client device or a multichannel WLAN access point. In some example embodiments, the processor 512 can be configured to execute instructions that can be stored in the memory 514 or that can be otherwise accessible to the processor 512. As such, whether configured by hardware or by a combination of hardware and software, the processor 512 can be capable of performing operations according to various embodiments while configured accordingly.

In some embodiments, the memory 514 can include one or more memory devices. Memory 514 can include fixed and/or removable memory devices. In some embodiments, the memory 514 can provide a non-transitory computer-readable storage medium that can store computer program instructions that can be executed by the processor 512. In this regard, the memory 514 can be configured to store information, data, applications, instructions and/or the like for enabling the apparatus 500 to carry out various functions in accordance with one or more embodiments. In embodiments including a plurality of memory devices, the plurality of memory devices can be implemented on a single computing device, or can be distributed across a plurality of computing devices that can collectively provide functionality of a multichannel WLAN client device or a multichannel WLAN access point. In some embodiments, the memory 514 can be in communication with one or more of the processor 512, communication interface 516, or management module 518 via one or more busses for passing information among components of the apparatus 500.

The apparatus 500 can further include a communication interface 516. The communication interface 516 can include one or more interface mechanisms for enabling communication with other devices and/or networks. For example, the communication interface 516 can be configured to enable the apparatus 500 to communicate over the network 108. The apparatus 500 can include multiple communication interfaces 516, which can each provide communication in accordance with a communication protocol, e.g., a wireless communication protocol. In various embodiments, the communication interface 516 can include, for example, an antenna (or multiple antennas) and supporting hardware and/or software for enabling communications with one or more wireless communication networks, such as a cellular network, and/or a communication modem or other hardware/software for supporting communication via cable, digital subscriber line (DSL), USB, FireWire, Ethernet or other wire-line networking methods.

The apparatus 500 can further include a WLAN management module 518. The WLAN management module 518 can be embodied as various means, such as circuitry, hardware, a computer program product comprising computer readable program instructions stored on a non-transitory computer readable medium (for example, the memory 514) and executed by a processing device (for example, the processor 512), or some combination thereof. In some embodiments, the processor 512 (or the processing circuitry 510) can include, or otherwise control the WLAN management module 518. The WLAN management module 518 can be configured to support management of wireless communication in accordance with multichannel basic service sets (BSSs) as described herein, and/or other functions that can be performed by a multichannel WLAN client device and/or multichannel WLAN access point in support of one or more example embodiments.

Representative applications of systems, methods, apparatuses, and computer program products according to the present disclosure are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The various aspects, embodiments, implementations or features of the described embodiments can be used separately or in any combination. Various aspects of the described embodiments can be implemented by software, hardware or a combination of hardware and software. The described embodiments can also be embodied as computer readable code on non-transitory a computer readable medium. The non-transitory computer readable medium is any data storage device that can store data, which can thereafter be read by a computer system. Examples of the computer readable medium include read-only memory, random-access memory, CD-ROMs, HDDs, DVDs, magnetic tape, and optical data storage devices.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to operate a wireless access point, the method comprising:
by the wireless access point:
communicating over a first logical channel associated with a single physical radio frequency channel to one or more single channel wireless client devices, the first logical channel including a combination of data traffic, control traffic, and management frames;
communicating over a second logical channel associated with a first set of one or more physical radio frequency channels to one or more multichannel wireless client devices, the second logical channel including management frames; and
communicating over a third logical channel associated with a second set of one or more physical radio frequency channels to the one or more multichannel wireless client devices, the third logical channel including a combination of data traffic and control traffic.

2. The method of claim 1, wherein the first set of one or more physical radio frequency channels belong to a first radio frequency band and the second set of one or more physical radio frequency channels belong to a second radio frequency band that does not overlap the first radio frequency band.

3. The method of claim 1, wherein the management frames include one or more of: beacon frames, probe requests, probe responses, authentication frames, association requests, and association responses.

4. The method of claim 1, wherein the single physical radio frequency channel is located at a band edge of a radio frequency band.

5. The method of claim 1, wherein the single physical radio frequency channel occupies a bandwidth of less than 20 MHz within an Industrial, Scientific, and Medical (ISM) ISM radio frequency band.

6. The method of claim 1, wherein the first set of one or more physical radio frequency channels and the second set of one or more physical radio frequency channels each comprise a plurality of physical radio frequency channels.

7. The method of claim 6, wherein the second set of one or more physical radio frequency channels comprise a plurality of noncontiguous physical radio frequency channels in at least two different radio frequency bands.

8. The method of claim 1, wherein the first logical channel is used by the wireless access point to communicate in accordance with a legacy 802.11 wireless communication protocol over the single physical radio frequency channel, and wherein the second and third logical channels are used by the wireless access point to communicate using multiple physical radio frequency channels in parallel.

9. The method of claim 8, wherein the second and third logical channels are associated with a single common basic service set identifier (BSSID).

10. The method of claim 1, wherein the third logical channel does not include management frames and the second logical channel does not include data traffic or control traffic.

11. The method of claim 1, wherein the first set of one or more physical radio frequency layer channels comprises at least one narrow bandwidth radio frequency channel occupying less than 20 MHz of bandwidth and positioned between two 20 MHz bandwidth radio frequency channels of the 2.4 GHz ISM radio frequency band.

12. A wireless access point configured to support communication using multiple radio frequency channels simultaneously for a basic service set (BSS), the wireless access point comprising:
at least one communication interface; and
processing circuitry communicatively coupled to the at least one communication interface and configured to cause the wireless access point to:
communicate over a first logical channel associated with a single physical radio frequency channel to a first wireless client device, the first logical channel including a combination of data traffic, control traffic, and management frames;
communicate over a second logical channel associated with a first set of one or more physical radio frequency channels to a second wireless client device, the second logical channel including management frames; and
communicate over a third logical channel associated with a second set of one or more physical radio frequency channels to the second wireless client device, the third logical channel including a combination of data traffic and control traffic.

13. The wireless access point of claim 12, wherein the first set of one or more physical radio frequency channels belongs to a first radio frequency band and the second set of one or more physical radio frequency channels comprises a plurality of radio frequency channels of a second radio frequency band that does not overlap the first radio frequency band.

14. The wireless access point of claim 12, wherein the management frames include one or more of: beacon frames, probe requests, probe responses, authentication frames, association requests, and association responses.

15. The wireless access point of claim 12, wherein the wireless access point communicates over the first logical channel in accordance with a legacy 802.11 wireless communication protocol over the single physical radio frequency channel, and the wireless access point communicates over the second and third logical channels using multiple physical radio frequency channels in parallel.

16. The wireless access point of claim 15, wherein the second and third logical channels are associated with a single common BSSID.

17. A wireless client device comprising:
at least one communication interface; and
processing circuitry communicatively coupled to the at least one communication interface and configured to cause the wireless client device to:
in a first communication mode, communicate with a first wireless access point according to a legacy 802.11 wireless communication protocol over a first logical channel associated with a single physical radio frequency channel, the first logical channel including a combination of data traffic, control traffic, and management frames; and
in a second communication mode, communicate with a second wireless access point over one or more logical channels using multiple physical radio frequency channels in parallel.

18. The wireless client device of claim 17, wherein the one or more logical channels comprise:
a second logical channel associated with a first set of the multiple physical radio frequency channels, the second logical channel including management frames, and
a third logical channel associated with a second set of the multiple physical radio frequency channels, the third logical channel including a combination of data traffic and control traffic.

19. The wireless client device of claim 18, wherein the management frames include one or more of: beacon frames, probe requests, probe responses, authentication frames, association requests, and association responses.

20. The wireless client device of claim 18, wherein the second and third logical channels are associated with a single common BSSID.
